(19) United States
(12) Patent Application Publication
(10) Pub. No.: US 2013/0318814 A1
(43) Pub. Date: Dec. 5, 2013

(54) Apparatus for Drying Wet Objects in a Drying Container by Using Heat Emitted from Heat-Emitting Louvers

(71) Applicant: Sergey Anikin, Atherton, CA (US)

(72) Inventor: Sergey Anikin, Atherton, CA (US)

(21) Appl. No.: 13/484,165

(22) Filed: May 30, 2012

(51) Int. Cl. F26B 25/06; F26B 3/02

(52) U.S. Cl. 34/487; 34/202

(57) ABSTRACT

The apparatus of the invention is intended for drying wet clothing by using heat emitted through the louvers of an air conditioner in a vehicle or a wall-mounted room air conditioner. The apparatus comprises a sealable container that has an inlet port and an outlet port. The apparatus is provided with a flexible inlet hose, one end of which has a cup-shaped adapter for attachment to the air conditioning vent on the dashboard of the vehicle. The adapter is made from a soft and transparent plastic and contains inside its body two hooks that can be engaged with the racks of the louvers of the air conditioner vent. Transparency of the adapter body facilitates connection to the air-conditioner vent. Wet air exhausts to the outside of the vehicle through the outlet hose that connects to the outlet port of the container.

### FIELD OF THE INVENTION

The invention relates to the field of drying wet objects, in particular to drying wet clothing, shoes, etc., by using heat emitted from heat-emitting louvers, e.g., from the louvers of the air-conditioning system inside a vehicle. Such a necessity may occur under various conditions, e.g., the need to dry wet clothing during wet-weather camping, after a sporting event and before proceeding to another location, in hot weather, and with the absence of drying equipment in a home or shared apartment.

In principle, the drying of wet clothing in a vehicle is known. For example, U.S. Pat. No. 7,410,415 issued on Aug. 12, 2008 to Ronnlund, et al, describes a system for ventilating vehicle cabs equipped with a special drying compartment. The system consists of a fan in a cab compartment and a fan that extracts air from the cab through the compartment. Excess heat from the coolant circuit in the engine is used as the heat source. The system can be advantageously used when the cab is occupied overnight.

U.S. Pat. No. 7,273,154 issued on Sep. 25, 2007 to Edwards discloses a portable clothesline assembly for vehicles. On extended camping trips of more than a few days, people often find it necessary to launder their clothing. However, many recreational vehicles are not provided with a means for laundering or drying clothing. Although the clothing can be washed in a sink or a small plastic basin, drying the clothing can still be a problem. Thus, people are often required to suspend wet clothing from tree limbs or other insufficient structures. The portable clothesline assembly of U.S. Pat. No. 7,273,154 is intended to dry wet clothing in camper vehicles, or the like.

Also known in the art is a device that allows use of the air conditioner in a vehicle for cooling or drying one's body or wet clothing worn by a driver when the latter needs to stay in the vehicle. This device is disclosed in U.S. Pat. No. 7,437,883 issued on Sep. 21, 2008 to Baldal. For example, when law enforcement officers work in warm climates or climates having high humidity, quite often they become hot and sweaty while riding in their vehicles. When a protective armor vest must be worn, the law enforcement officer is even more uncomfortable. In these situations, no amount of air emitted from the vehicle air vents can keep the officer cool and dry. The device of U.S. Pat. No. 7,437,883 solves this problem. It comprises a body armor cooling system having a hook-shaped nozzle attached to one end of a flexible hose and a bellows assembly attached to the other end of the flexible hose. The end of the hook-shaped nozzle is tucked beneath the protective armor worn by the law enforcement officer in order to provide a cooling effect. The bellows assembly is connected to the air conditioner vent opening on the dash of the vehicle. The bellows assembly makes an airtight seal with the dash of the vehicle and can be easily attached and detached. However, none of the known devices and systems described above allows efficient drying of wet objects, such as clothing, in any type of vehicle.

### SUMMARY OF THE INVENTION

The apparatus of the invention is intended for drying wet clothing by using heat emitted through the louvers of the air conditioner in a vehicle, e.g., directly in a salon of a vehicle by using heat emitted from an air conditioner of the vehicle. The apparatus comprises a sealable object-drying container that is made from an air-impermeable material and provided with a cover that can be opened for access to a clothing-holding means such as a rack located in the container's interior and capable of supporting clothing items in positions spaced apart from each other for more efficient drying. The container has an inlet port and an outlet port. The apparatus is provided with a flexible inlet hose that may have a bellows-type stretchable structure or may comprise a conventional nonexpandable gas-proof hose of the type used in a vacuum cleaner. One end of the inlet hose has a cup-shaped adapter for attachment to the air conditioner vents on the dashboard of the vehicle. The adapter is made from a soft and transparent plastic and contains inside its body two hooks that can be engaged with the racks of the louvers of the air conditioning vent. The ends of the hook are located deeper than the end face of the adapter so that after the adapter covers the wall around the louvers of a room's air conditioner or the vent on the dashboard of a vehicle. Pressing the adapter body to the wall or to the dashboard expands it, thereby allowing engagement of the hooks with the racks of the louvers. Transparency of the adapter body facilitates the connection procedure while the deformed state of the adapter body when pressed to the dashboard maintains sealing of the connection. Another item of the system is an outlet hose. One end of the outlet hose can be connected to the outlet port of the object-drying container, and the opposite end can be brought outside the vehicle, e.g., through a window or through another opening specially provided in the vehicle for exhaust of humid air.

### BRIEF DESCRIPTION OF THE DRAWINGS

FIG. 1 is a block-diagram of the system of the invention for drying wet clothing in a vehicle by using the heat emitted from the air conditioning system.

FIG. 2 is a three-dimensional view of the object-drying container of the invention.

FIG. 3 is a three-dimensional view of the connection adapter for the apparatus in FIG. 1.

### DETAILED DESCRIPTION OF THE INVENTION

Although the invention is further illustrated with reference to wet clothing, the invention also applies to any other wet objects such as shoes, sports gear, etc. Furthermore, although the invention is described with reference to the heat source emitted from the air conditioning system in a vehicle, the device of the invention can be used with any other source of heat having a vent that can be covered by the end face of an adapter, such as an air conditioner built into the wall of a room.

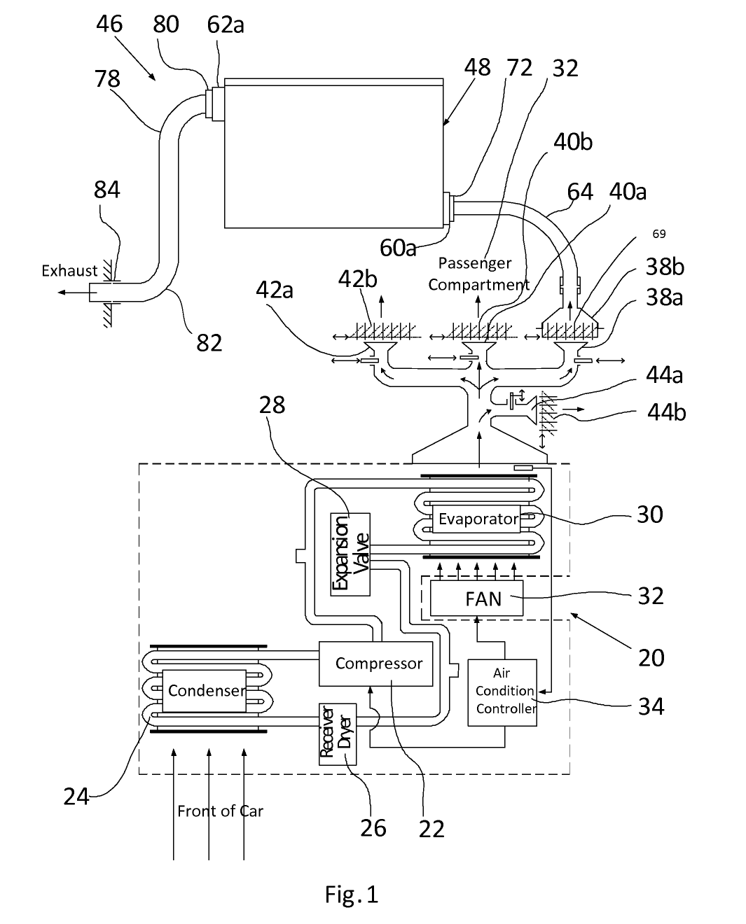

Shown in FIG. 1 is a block-diagram of the system of the invention for drying wet objects, e.g., wet clothing in a vehicle by using the heat emitted from the air conditioning system. Although the air conditioner 20 shown in FIG. 1 is known per se and remains unchanged, the structure thereof is schematically shown in FIG. 1 for convenience of explanation of the invention. Six main components in a vehicle air conditioner 20 that are connected to each other in a predetermined sequence are shown in the drawings. These components are the following a compressor 22, a condenser 24, a receiver-drier 26, a thermostatic expansion valve 28, an evaporator 30, and a refrigerant (not shown). Other components are a fan 32 and an air conditioner controller 34 with control elements located on the dashboard of the vehicle.

When the air conditioner system 20 is activated by turning on the air conditioner controller 34, the compressor 22 begins to pump out refrigerant vapor under high pressure and high heat to the condenser 24. The condenser 24 changes the high-pressure refrigerant vapor to a liquid. As the car moves, air flowing through the condenser 24 removes heat from the refrigerant, changing it to a liquid state. The refrigerant moves to the receiver-drier 26, which is the storage tank for the liquid refrigerant and which also removes moisture from the refrigerant. As the compressor 22 continues to pressurize the system, liquid refrigerant under high pressure circulates from the receiver-drier 26 to the thermostatic expansion valve 28. The valve 28 removes pressure from the liquid refrigerant so that it can expand and become refrigerant vapor in the evaporator 30.

The evaporator is very similar to the condenser. The evaporator consists of tubes and fins and is usually mounted inside the passenger compartment. The cold low-pressure refrigerant is released into the evaporator 30, vaporizes, and then absorbs heat from the air in the passenger compartment 32. As the heat is absorbed, cool air is available for the occupants of the vehicle. A blower fan 32 inside the passenger compartment helps to distribute the cooler air. The heat-laden, low-pressure refrigerant vapor is then drawn into the compressor 22 to start another refrigeration cycle.

To switch the conditioner mode from cooling to heating, the driver turns the air conditioner control member 34 from cooling to heating. In this case, the rate of refrigerant flow in the heat-exchange system is reduced. The amount of heat obtained by the condenser 24 from the vehicle engine (not shown). As a result, the temperature of the refrigerant in the evaporator 30 also increases, and the air conditioner emits hot air. The temperature of the emitted air depends on the position of the control element of the controller 34 and the power of the fan 32.

Modern cars generally have more than one air conditioning vent. FIG. 1 illustrates an air conditioning system that has four vents, three of which (38a, 40a, and 42a) are located on the dashboard (not shown) and one (44a) of which may be located in the backseat passenger area. Reference numerals 38b, 40b, 42b, and 44b designate louvers of the respective vents 38a, 40a, 42a, and 44a (FIG. 1)

The air conditioning system 20 described thus far does not constitute a subject of the present invention and is considered only for convenience of further description. It is also understood that the vehicle air conditioner 20 is given as an example and that, e.g, the vent 38a, may belong to a room air conditioner.

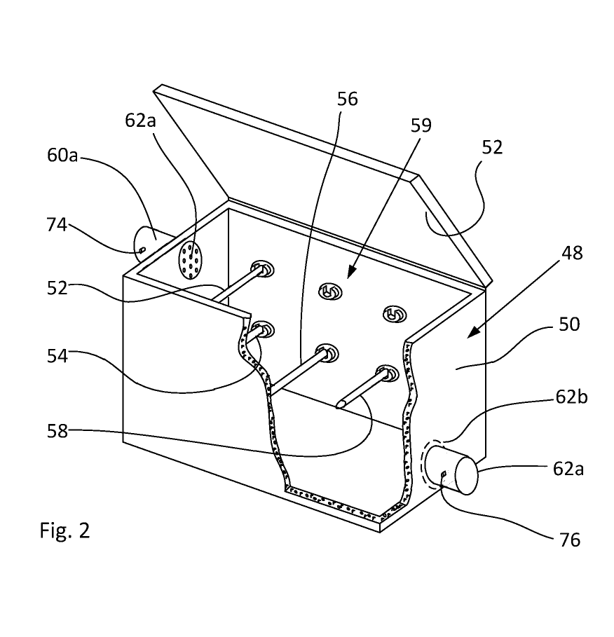

The main component of the invention is an apparatus 46 for drying wet clothing by using heat emitted from vehicle air conditioner 20. The apparatus 46 comprises a sealable object-drying container 48 and is shown in FIG. 1 and in further detail in FIG. 2, which is a three-dimensional view of the container 48. The container 48 has a hollow body 50 made from an air-impermeable material, e.g., a heat-insulating material such as foam plastic, and is provided with a cover 50 that can be opened for access to means for supporting clothing such as rack rods 52, 54, 56, and 58 located in the container's interior 59 and capable of supporting clothing items (not shown) in positions spaced apart from each other for more efficient drying.

The container has an inlet pipe union 60a and an outlet pipe union 62a (FIG. 1) at an inlet port 62a and an outlet port 62b, respectively. The apparatus 46 (FIG. 1) is provided with a flexible inlet hose 64 that may have a bellows-type stretchable structure or may comprise a conventional nonexpandable gas-proof hose of the type used in a vacuum cleaner.

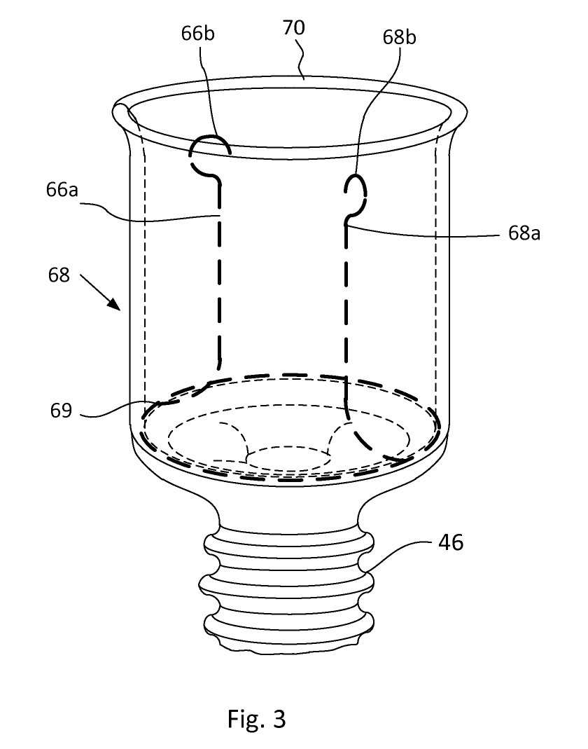

As shown in FIG. 1 and in FIG. 3, which is a three-dimensional view of a connection part of the inlet hose 64, one end of the inlet hose 64 has a cup-shaped adapter 68 for attachment to a selected air conditioning vent on the dashboard of the vehicle. In the illustrated case, this is the outlet air conditioner vent 38a (FIG. 1). The adapter 68 has means for connection to the outlet vent of the air conditioner. Although these connection means may have any other structure and principle of connection, in the illustrated embodiment the adapter is made from a soft and transparent plastic and contains inside its body connection elements, e.g., two hooks 66a and 68a, that can be engaged with the racks of the louvers, e.g., louvers 69 (FIG. 1) of the air conditioner vent 38a. The rear ends of the hooks 66a and 68a are secured to a metal ring 69 that is fixed in the body of the cup-shaped adapter 68. The front ends 66b and 68b of the hooks 66a and 68a, respectively, are located deeper than the end face 70 of the adapter 68 so that after the adapter 68 covers the vent 38a on the dashboard of the vehicle, pressing the adapter body toward the dashboard expands the adapter body in the radial outward direction and allows engagement of the hooks 66a and 68a with the racks of the louvers 69. The end of the inlet hose 64 opposite the adapter 68 has conventional bayonet-type connectors 72 (FIG. 1).

Transparency of the adapter body facilitates the connection procedure, while the deformed state of the adapter body when pressed to the dashboard maintains sealing of the connection.

An additional item of the system is an outlet hose 78. One end of the outlet hose 78 (shown in FIG. 1) can be connected to the outlet pipe union 62a (FIG. 1) of the object-drying container 48 by means of a bayonet connector 80. The opposite end 82 of the outlet hose 78 can be placed outside the vehicle, e.g., through a window or through another opening 84 (FIG. 1) specially provided in the vehicle for exhaust of humid air from the drying container 48.

The bayonet-type connectors 72 and 80 on the ends of both hoses 64 and 78 have circular slots (not shown) for engagement with locking pins 74 and 76 (FIG. 2), respectively, that are provided on the pipe unions 60a and 62a.

When it is necessary to dry wet clothing in the passenger compartment 32 (FIG. 1), the control member of the air conditioner controller 34 (FIG. 1) is set to an appropriate heating position that adjusts the temperature of the hot air emitted from the air conditioner. Wet clothing is placed on the rack rods 52, 54, etc. (FIG. 2), the container 48 is closed with the cover 50, the bayonet connectors 72 and 80 of the hoses 64 and 78 are connected to the inlet pipe unions 60a and 62a of the object-drying container 48, and the end 82 of the outlet hose 78 is placed outside the passenger compartment 32, e.g., through the opening 84 in the window or in the floor of the vehicle. The user selects an appropriate vent of the air conditioner, e.g., the vent 38a. The remaining vents can be kept open or closed by control means that are always available in modern vehicles for maintaining a comfortable climate in the passenger compartment. The cup-shaped adapter 68 is then pressed against the dashboard over the air conditioner vent 38a so that the lower part of the adapter expands and the hooks 66b and 68b (FIG. 3) that are seen through the transparent body of the adapter 68 are engaged with the louvers 69 of the vent 38a.

The hot air emitted from the vent 38a of the air conditioner 20 passes through the inlet hose 64 to the interior of the container 48 and is emitted from the container 48 through the outlet hose 78. On its way through the container 48, the hot air dries the wet clothing supported by the rack rods 52, 54, etc., and removes moisture from the box 48.

Reference numeral 63 in FIG. 2 designates a moisture absorbing filter installed at the inlet port of the container 48,

Although the invention is shown and described with reference to a specific embodiment, it is understood that these embodiments should not be construed as limiting the areas of application of the invention and that any changes and modifications are possible provided that these changes and modifications do not depart from the scope of the attached patent claims. For example, the object-drying container may not be necessarily rectangular and may have a round, oval, or any other shape. The hose adapters may be connected to the air-conditioner vent by means other than hooks. The clothing-holding means of the container may comprise hooks, strings, etc. By using air cooled by the air conditioner, the same system can be used for cooling food products stored in the drying box instead of the clothing. If necessary and the length of the inlet hose allows during use, the object-drying container may be placed outside the vehicle.

1. An apparatus for drying wet objects by using heat emitted from heat-emitting louvers of an air conditioner, the apparatus comprising:
an object-drying container made from a heat-resistant material and having a cover capable of sealing a container, an air inlet port, an air outlet port, and means for supporting objects to be dried;
a flexible air inlet hose having at one end an adapter for connection to the vent of a vehicle air conditioner and having at another end means for connection to the air inlet port of the object-drying container; and
a flexible air outlet hose having at one end means for connection to the air outlet port of the object-drying container.

2. The apparatus of claim 1, wherein the container has an interior and clothing-supporting means secured in said interior, the adapter having connection elements for engagement with the louvers of the vehicle air conditioner.

3. The apparatus of claim 1, wherein connection elements for engagement with the louvers of an air conditioner comprise at least a pair of hooks secured in the cup-shaped body, said cup-shaped body having an end face; said hooks having ends located deeper than the end face of the cup-shaped body, the hooks having dimensions that allow engagement with the louvers for connection of the adapter to the vent.

4. The apparatus of claim 3, wherein the cup-shaped body is made from a transparent plastic material.

5. The apparatus of claim 2, wherein the adapter for connection to the air conditioner comprises a cup-shaped body having an end face and at least a pair of hooks secured in the cup-shaped body, said hooks having ends located deeper than the end face of the adapter, the hooks having dimensions that allow engagement with the louvers for connection of the adapter to the air conditioner

6. The apparatus of claim 5, wherein the cup-shaped body is made from a transparent plastic material.

7. The apparatus of claim 2, wherein the objects comprise wet clothing and the clothing-supporting means comprise rack rods.

8. The apparatus of claim 3, wherein the object-supporting means comprise rack rods.

9. The apparatus of claim 4, wherein the clothing-supporting means comprise rack rods.

10. The apparatus of claim 1, wherein the air inlet port comprises an inlet pipe union, the air outlet port comprises an outlet pipe union, the means of the flexible inlet hose for connection to the air inlet port comprises a first bayonet-type connector, and the means of the flexible outlet hose for connection to the outlet port comprises a second bayonet-type connector.

11. The apparatus of claim 2, wherein the air inlet port comprises an inlet pipe union, the air outlet port comprises an outlet pipe union, the means of the flexible inlet hose for connection to the air inlet port comprises a first bayonet-type connector, and the means of the flexible outlet hose for connection to the outlet port comprises a second bayonet-type connector.

12. The apparatus of claim 5, wherein the air inlet port comprises an inlet pipe union, the air outlet port comprises an outlet pipe union, the means of the flexible inlet hose for connection to the air inlet port comprises a first bayonet-type connector, and the means of the flexible outlet hose for connection to the outlet port comprises a second bayonet-type connector.

13. The apparatus of claim 6, wherein the air inlet port comprises an inlet pipe union, the air outlet port comprises an outlet pipe union, the means of the flexible inlet hose for connection to the air inlet port comprises a first bayonet-type connector, and the means of the flexible outlet hose for connection to the outlet port comprises a second bayonet-type connector.

14. The apparatus of claim 7, wherein the air inlet port comprises an inlet pipe union, the air outlet port comprises an outlet pipe union, the means of the flexible inlet hose for connection to the air inlet port comprises a first bayonet-type connector, and the means of the flexible outlet hose for connection to the outlet port comprises a second bayonet-type connector.

15. The apparatus of claim 1, wherein the air conditioner is selected from the group consisting of a vehicle air conditioner and a room air conditioner.

16. The apparatus of claim 4, wherein the air conditioner is selected from the group consisting of a vehicle air conditioner and a room air conditioner.

17. The apparatus of claim 12, wherein the air conditioner is selected from the group consisting of a vehicle air conditioner and a room air conditioner.

18. A method for drying wet object by using heat emitted from the vent of an air conditioner, the vent having louvers and the method comprising the following steps:
providing an object-drying container having an inlet hose and an outlet hose connected to the object-drying container;
connecting the inlet hose to the vent of the air conditioner;
placing objects to be dried into the container;
setting the air conditioner to the heating mode; and
passing the hot air emitted from the air conditioner through the object-drying container by feeding the hot air into the container through the inlet hose and removing the air from the object-drying container through the exhaust hose.

19. The method of claim 18, wherein the air conditioner is selected from the group consisting of a vehicle air conditioner and a room air conditioner.
